(19) United States
(12) Patent Application Publication
(10) Pub. No.: US 2025/0077225 A1
(43) Pub. Date: Mar. 6, 2025

(54) INFORMATION PROCESSING APPARATUS

(71) Applicant: SUBARU CORPORATION, Tokyo (JP)

(72) Inventors: Hisataro IINAMI, Tokyo (JP); Yusuke KOMATSU, Tokyo (JP)

(73) Assignee: SUBARU CORPORATION, Tokyo (JP)

(21) Appl. No.: 18/769,692

(22) Filed: Jul. 11, 2024

(30) Foreign Application Priority Data
Sep. 4, 2023 (JP) 2023-142761

(51) Int. Cl. G06F 8/658; G06F 8/71

(52) U.S. Cl. CPC G06F 8/658; G06F 8/71

(57) ABSTRACT

An information processing apparatus includes a processor(s) and a storage medium storing a program. The program causes the processor(s) to execute: a first reception process for receiving partial data in update data other than including a first software program and first version information indicating a version of the first software program and stored in an area closer to a head than the first software program; a process for storing the partial data in a first storage area; a process for comparing the first version information and second version information indicating a version of a pre-update second software program stored in a second storage area for the first software program; and a process for storing, in the second storage area, the first software program received by a second reception process subsequent to the first reception process when the first version information is determined to be newer than the second version information.

### CROSS-REFERENCE TO RELATED APPLICATION

The present application claims priority from Japanese Patent Application No. 2023-142761 filed on Sep. 4, 2023, the entire contents of which are hereby incorporated by reference.

### BACKGROUND

The disclosure relates to a technical field for updating software of an information processing apparatus mounted on a vehicle.

Vehicles include many information processing apparatuses such as electronic control units (ECUs) by electronification of control.

The information processing apparatuses are updated to remove bugs in and improve the performance of software programs (see, for example, Japanese Unexamined Patent Application Publication No. 2023-052938).

### SUMMARY

An aspect of the disclosure provides an information processing apparatus including one or more processors and a storage medium. The storage medium stores a program configured to be executed by the one or more processors. The program includes one or more instructions. The one or more instructions are configured to cause the one or more processors to execute a first reception process for receiving partial data in update data including a first software program and first version information indicating a version of the first software program and stored in an area closer to a head than is the first software program. The partial data includes the first version information and does not include the first software program. The one or more instructions cause the one or more processors to execute a process for storing the partial data in a first storage area. The one or more instructions cause the one or more processors to execute a process for comparing the first version information in the partial data and second version information as to which is newer. The second version information indicates a version of a pre-update second software program stored in a second storage area expected to store the first software program. The one or more instructions cause the one or more processors to execute a process for storing, in the second storage area, the first software program received by a second reception process subsequent to the first reception process when the first version information is determined to be newer than the second version information.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a block diagram illustrating an example of the configuration of a vehicle;

FIG. 2 illustrates a communication path between the vehicle and a server;

FIG. 3 is a block diagram illustrating an example of the configuration of an ECU;

FIG. 4 is a block diagram illustrating an example of the configuration of a computer;

FIG. 5 illustrates the process of generating update data from a software program;

FIG. 6 illustrates the process of generating encrypted update data from the update data;

FIG. 7 is a flowchart illustrating an example of a process to be executed by a CGWECU as an update process;

FIG. 8 is a flowchart illustrating, together with FIG. 9, an example of a process to be executed by an update target ECU;

FIG. 9 is a flowchart illustrating, together with FIG. 8, the example of the process to be executed by the update target ECU;

FIG. 10 is a flowchart illustrating an example of a process to be executed by the server in the update process; and

FIG. 11 is a flowchart illustrating an example of a process to be executed by a coupling terminal in the update process.

### DETAILED DESCRIPTION

A coupling terminal (external terminal) including a reprogramming tool may be used to update a software program.

The coupling terminal avoids downgrading to an old version by comparing the version of a software program installed in an ECU and the version of a software program to be written.

If the coupling terminal has undergone tampering, there is a possibility that downgrading in the ECU cannot be avoided, for example, because the version comparison process is disabled.

It is desirable to update the software program appropriately.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

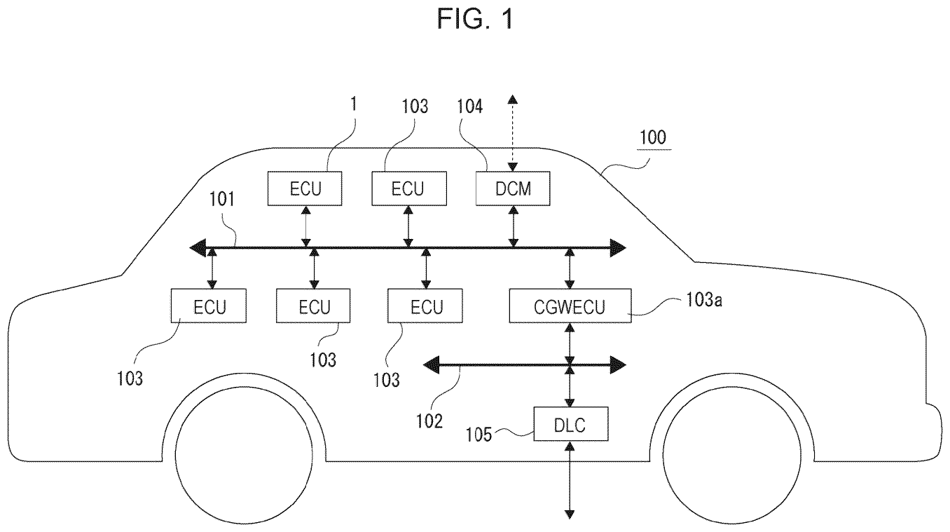

FIG. 1 illustrates an example of the configuration of a vehicle 100 including an ECU 1 serving as an information processing apparatus according to the embodiment of the disclosure.

The vehicle 100 includes a first bus 101 and a second bus 102. Examples of the first bus 101 and the second bus 102 include a bus using controller area network (CAN: registered trademark) communication. With the first bus 101 and the second bus 102, devices can exchange information.

The ECU 1, various other ECUs 103 than the ECU 1, and a data communication module (DCM) 104 are coupled to the first bus 101.

The ECU 1 and the various ECUs 103 are described.

Examples of the ECUs 103 include an air conditioner ECU (ACECU), an engine control ECU, a charging control ECU, an airbag ECU, and a display control ECU.

A software program SWP is installed in each ECU 103 to exert a predetermined function. When a new software program SWP is provided, the ECU 103 updates the software program SWP at any timing.

In the following description, the ECU 1 is defined as an ECU 103 whose software program SWP is to be updated. The ECU 103 is an ECU whose software program SWP is not to be updated.

The ECUs 103 include an ECU 103 having a gateway function for the vehicle. This ECU 103 is referred to as “central gateway electronic control unit (CGWECU) 103a”. The CGWECU 103a may serve as the update target ECU 1.

The CGWECU 103a receives, from an external apparatus, update data Du for updating the software program SWP installed in the ECU 1 coupled to the first bus 101.

The CGWECU 103a supplies the received update data Du to the ECU 1.

The ECU 1 that has received the update data Du checks the validity of the update data Du by executing a predetermined process described later, and then executes a process of updating the software program SWP by using the update data Du.

The DCM 104 is a vehicle communication device that communicates data with other apparatuses via an external communication network NW. For example, the DCM 104 may acquire the update data Du from an external file server (e.g., a server 300 described later) by an over-the-air (OTA) method. The acquired update data Du is provided to the CGWECU 103a via the first bus 101.

The CGWECU 103a and a data link connector (DLC) 105 are coupled to the second bus 102.

The DLC 105 is provided as, for example, a connector to which a device that executes communication by on-board diagnostics II (OBD II) is coupled.

The DLC 105 can acquire the update data Du from a coupled external device (e.g., a coupling terminal 200 described later). The acquired update data Du is provided to the CGWECU 103a via the second bus 102.

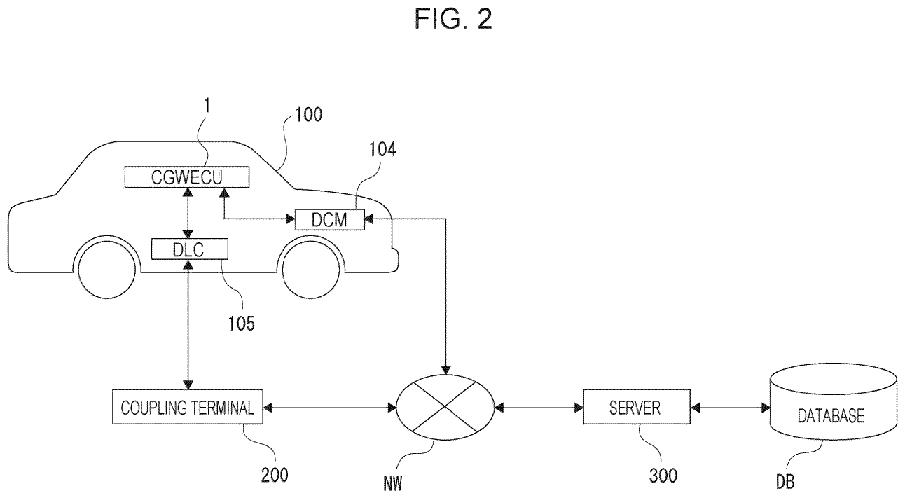

FIG. 2 illustrates a communication path on which the update data Du acquired via the DLC 105 is provided to the CGWECU 103a. In FIG. 2, illustration of the buses of the vehicle 100 is omitted.

The coupling terminal 200 is coupled to the vehicle 100 via the DLC 105.

A reprogramming tool (hereinafter referred to as “RT”) is installed in the coupling terminal 200. With the RT, update operations can be performed for the CGWECU 103a and other ECUs 103.

The coupling terminal 200, the DCM 104 of the vehicle 100, and the server 300 are coupled to the communication network NW.

A database DB is coupled to the server 300. The database DB stores the update data Du to be provided to the CGWECU 103a via the coupling terminal 200 or the DCM 104.

That is, the CGWECU 103a acquires, via the DLC 105 or the DCM 104, the update data Du that has been acquired by the server 300 from the database DB, and provides the update data Du to the update target ECU 1. The ECU 1 that has received the update data Du updates the software program SWP after verifying the validity.

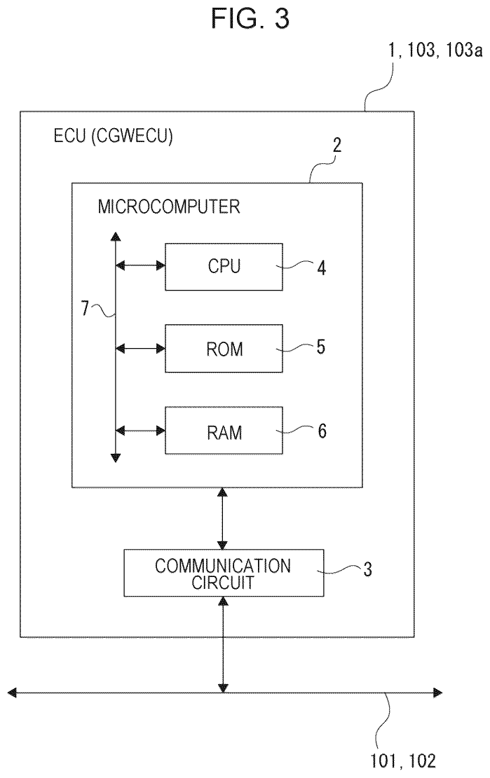

The configuration of each of the ECU 1, the ECU 103, and the CGWECU 103a is described with reference to FIG. 3.

The ECU 1 includes a microcomputer 2 and a communication circuit 3.

The microcomputer 2 includes a central processing unit (CPU) 4, a read only memory (ROM) 5, and a random access memory (RAM) 6.

The CPU 4, the ROM 5, and the RAM 6 are coupled via a bus 7 to communicate with each other.

The CPU 4 executes various processes based on programs stored in the ROM 5 or programs loaded on the RAM 6.

For example, the CPU 4 of the update target ECU 1 executes a process of receiving part of the update data Du from the CGWECU 103a and decrypting the update data Du.

The CPU 4 compares version information Dver acquired from the update data Du and version information Dver of the software program SWP installed in the ECU 1, and determines whether to continue the update process.

When determination is made to continue the update process, the CPU 4 executes a process of receiving an unreceived part of the update data Du via the CGWECU 103a. The CPU 4 decrypts the received data and updates the software program SWP.

The data to be handled by the CPU 4 in such a process is temporarily stored in, for example, the RAM 6.

Examples of the ROM 5 include a non-volatile memory (NVM).

The communication circuit 3 controls data communication conforming to CAN communication standards via the first bus 101 or the second bus 102.

As illustrated in FIG. 3, each of the ECU 103 and the CGWECU 103a includes a microcomputer 2 and a communication circuit 3 similarly to the ECU 1.

The communication circuit 3 of the ECU 1 controls data communication conforming to CAN communication standards via the first bus 101.

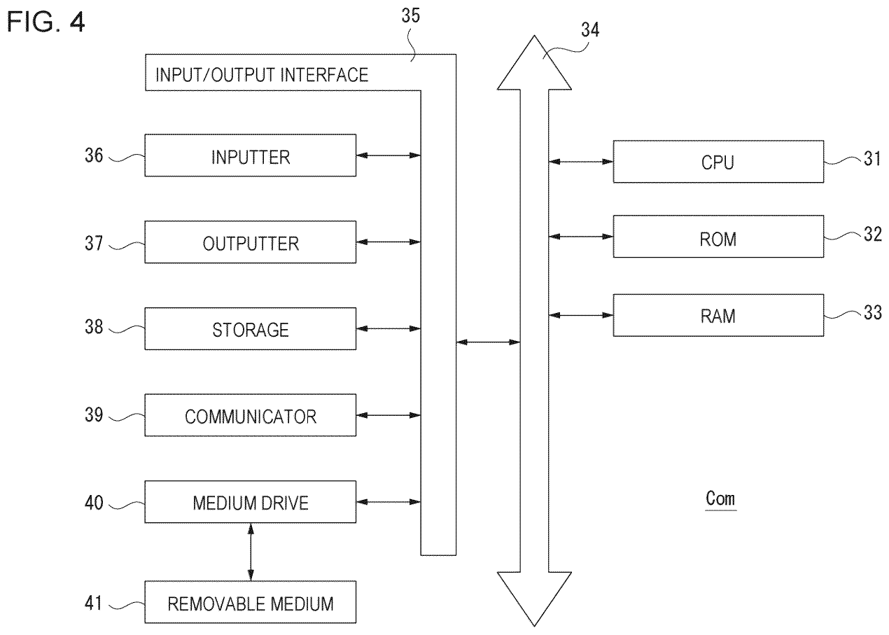

The configuration of a computer Com such as the coupling terminal 200 or the server 300 is described with reference to FIG. 4. Each computer Com need not include all the components illustrated in FIG. 4. For example, part of the components illustrated in FIG. 4 may be omitted from each computer Com, or any component that is not illustrated in FIG. 4 may be provided in each computer Com.

The computer Com includes a CPU 31, a ROM 32, a RAM 33, a bus 34, an input/output interface 35, an inputter 36, an outputter 37, a storage 38, a communicator 39, and a medium drive 40.

The CPU 31 executes various processes based on programs stored in the ROM 32 or programs loaded on the RAM 33 from the storage 38. The RAM 33 stores as appropriate data for various processes to be executed by the CPU 31.

The CPU 31, the ROM 32, and the RAM 33 are coupled to each other via the bus 34. The input/output interface 35 is also coupled to the bus 34.

The inputter 36, the outputter 37, the storage 38, the communicator 39, and the medium drive 40 are coupled to the input/output interface 35.

The inputter 36 includes a keyboard, a mouse, a touch panel, and a microphone.

The outputter 37 includes a display such as a liquid crystal display (LCD), a cathode ray tube (CRT), or an organic electroluminescence (EL) panel, and a loudspeaker.

The storage 38 includes a hard disk drive (HDD) and a flash memory.

The communicator 39 executes communication via the communication network NW and communication between devices.

A removable medium 41 such as a magnetic disk, an optical disc, a magneto-optical disk, or a semiconductor memory is inserted into the medium drive 40 as necessary, and information is written into and read from the removable medium 41.

In the computer Com, data and programs are uploaded and downloaded by communication via the communicator 39. Further, data and programs can be passed via the removable medium 41.

The CPU 31 executes processing operations based on various programs to execute information processing and communication in the computer Com.

The computer Com has various functions implemented by the CPU 31, the ROM 32, the RAM 33, etc.

For example, the computer Com serving as the server 300 achieves a process of acquiring the update data Du from the database DB and transmitting the update data Du.

For example, the computer Com serving as the coupling terminal 200 achieves a process of providing the update data Du received from the server 300 to the CGWECU 103a of the vehicle 100.

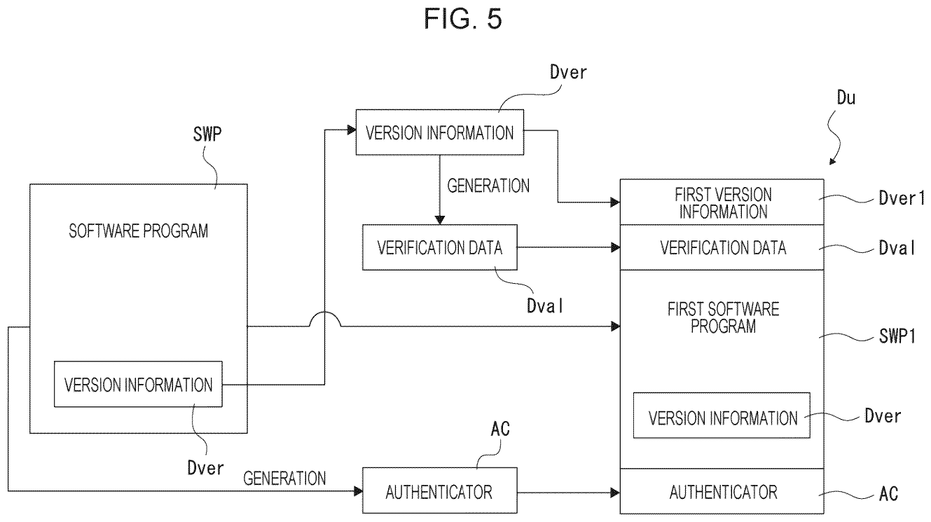

The structure of the update data Du is described with reference to FIG. 5.

For example, the update data Du is prepared by the server 300.

The CPU 31 of the server 300 prepares a software program SWP including version information Dver.

The CPU 31 of the server 300 generates verification data Dval for the version information Dver extracted from the software program SWP.

Examples of the verification data Dval include a cyclic redundancy check (CRC) code for error detection and error correction in the version information Dver.

The CPU 31 of the server 300 generates an authenticator AC by using the entire software program SWP including the version information Dver.

The authenticator AC is data for determination about the validity of the software program SWP. Examples of the authenticator AC include an electronic signature and a message authentication code (MAC).

The server 300 generates update data Du in which the version information Dver, the verification data Dval, the entire software program SWP, and the authenticator AC are arranged in sequence.

In the update data Du, the version information Dver extracted from the software program SWP and the verification data Dval are placed in an area closer to the head than is the software program SWP.

The version information Dver in a head area in the update data Du or in an area near the head area is referred to as “first version information Dver1” for distinction from old version information.

The software program SWP is also referred to as “first software program SWP1” for distinction from the old version.

The server 300 provides the update data Du in FIG. 5 to the CGWECU 103a via the coupling terminal 200 or the DCM 104.

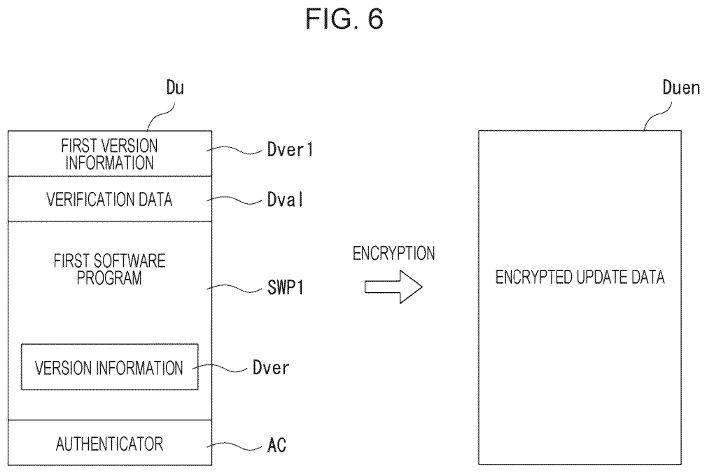

The server 300 may provide encrypted update data Duen obtained by encrypting the update data Du in FIG. 5 to the CGWECU 103a (see FIG. 6).

The authenticator AC may be generated from the encrypted update data Duen.

In the encrypted update data Duen, encrypted first version information Dver1 is stored in a head area or an area near the head area. The first version information Dver1 is stored at least in an area closer to the head than is the first software program SWP1.

In the process of encrypting the update data Du, a block cipher such as Advanced Encryption Standard (AES) or Camellia is used.

Thus, a predetermined area from the head of the encrypted update data Duen can be decrypted first in a decryption process, and the version can be verified without decrypting the entire data.

The pieces of information stored in the area closer to the head than is the first software program SWP1 in the update data Du are collectively referred to as “partial data Dp”.

That is, the partial data Dp includes at least the first version information Dver1 and the verification data Dval.

The partial data Dp in the encrypted update data Duen includes at least the encrypted first version information Dver1 and the encrypted verification data Dval.

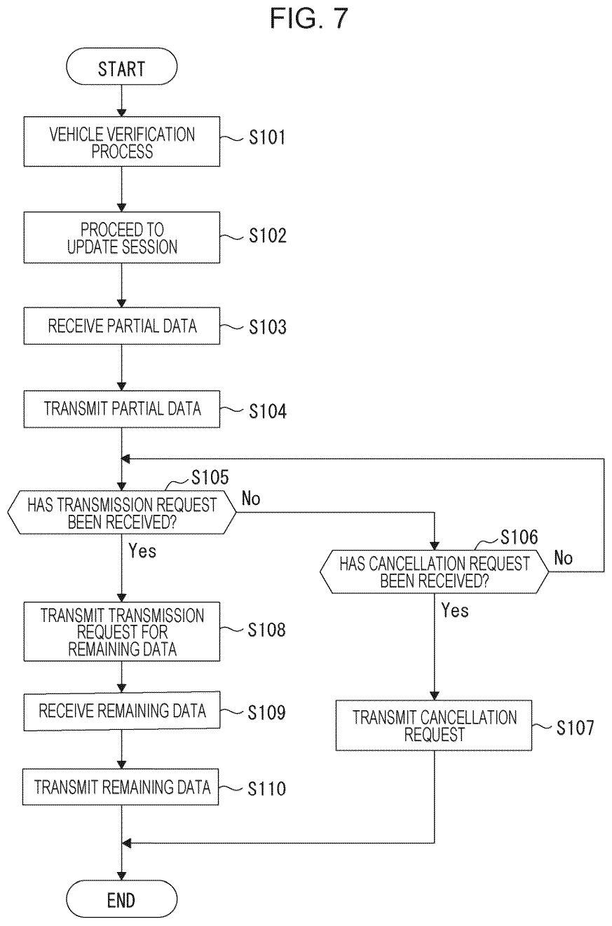

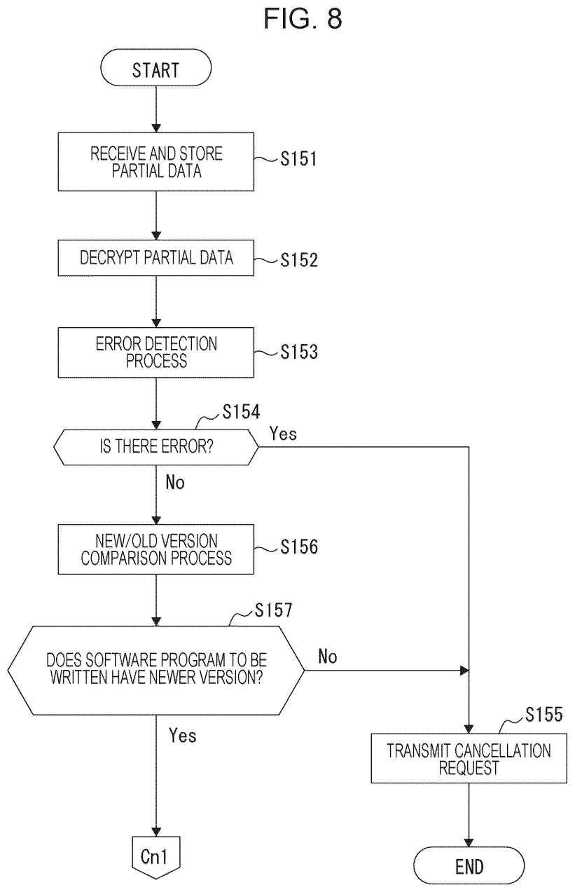

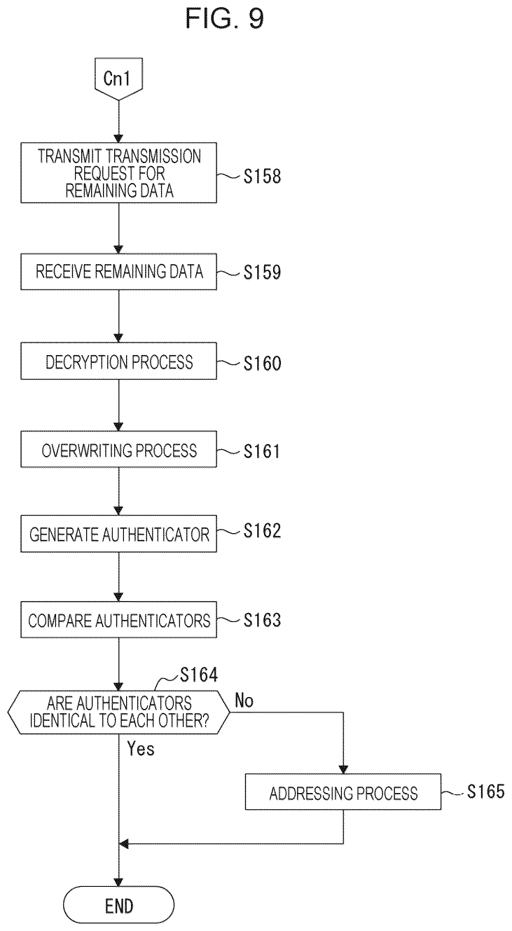

FIG. 7 illustrates an example of the update process to be executed by the CPU 4 of the CGWECU 103a of the vehicle 100 to update the software of the ECU 103 (or the CGWECU 103a). FIGS. 8 and 9 illustrate an example of the update process to be executed by the CPU 4 of the ECU 1.

In FIGS. 8 and 9, a connector Cnl represents connection of processes.

In Step S101 of FIG. 7, the CPU 4 of the CGWECU 103a executes a vehicle verification process. The vehicle verification process is a process of verifying whether the vehicle 100 is a target of update of the ECU 103 to be executed between the CGWECU 103a and the coupling terminal 200 (or the server 300). In the following process, transmission of update data Du from the coupling terminal 200 is described as an example.

In the vehicle verification process, the CPU 4 transmits, for example, the version information Dver of the software program SWP installed in the update target ECU 1 of the vehicle 100 or a vehicle identification number (VIN) for identifying the vehicle 100.

When the vehicle verification process has not properly ended, the CPU 4 terminates the series of processes illustrated in FIG. 7 without executing the processes of Step S102 onwards.

After the vehicle verification process has properly ended, the CPU 4 proceeds to an update session in Step S102.

In Step S103, the CPU 4 receives partial data Dp (e.g., data of several kilobytes from the head) in the encrypted update data Duen, and stores the partial data Dp, for example, in the RAM 6.

In Step S104, the CPU 4 executes a process of transmitting the partial data Dp to the ECU 1. At this time, the CPU 4 may transmit, to the coupling terminal 200, a stop request for temporarily stopping transmission of the remaining data subsequent to the partial data Dp.

In Step S105, the CPU 4 determines whether a transmission request for the remaining data subsequent to the partial data Dp has been received from the ECU 1.

When determination is made that the transmission request has not been received, the CPU 4 determines in Step S106 whether an update cancellation request has been received from the ECU 1.

When determination is made that the cancellation request has been received, the CPU 4 proceeds to Step S107 to transmit the cancellation request to the coupling terminal 200. Thus, the coupling terminal 200 avoids transmission of the remaining data subsequent to the partial data Dp, and cancels the update process without executing the update.

When determination is made that neither the transmission request nor the cancellation request has been received from the ECU 1, the CPU 4 of the CGWECU 103a executes the process of Step S105 again.

When determination is made in Step S105 that the transmission request has been received from the ECU 1, the CPU 4 proceeds to Step S108 to transmit, to the coupling terminal 200, the transmission request for the remaining data subsequent to the partial data Dp in the encrypted update data Duen.

In Step S109, the CPU 4 executes a reception process for receiving the remaining data. In Step S110, the CPU 4 executes a process of transmitting the received remaining data to the ECU 1, and terminates the series of processes illustrated in FIG. 7.

The process to be executed by the CPU 4 of the update target ECU 1 is described.

In Step S151 of FIG. 8, the CPU 4 of the ECU 1 receives the partial data Dp in the encrypted update data Duen from the CGWECU 103a, and stores the partial data Dp, for example, in the RAM 6.

In Step S152, the CPU 4 executes a process of decrypting the received partial data Dp.

In Step S153, the CPU 4 executes an error check process. In the error check process, the CPU 4 uses verification data Dval in the partial data Dp obtained by the decryption process of Step S152 to check whether an error is present in first version information Dver1 in the partial data Dp. At this time, predetermined bits of error may be corrected.

In Step S154, the CPU 4 determines whether an error is present. When error correction has been executed in Step S153, the CPU 4 may determine in Step S154 whether the error correction has been executed appropriately.

When determination is made that an error is present or when an error has been corrected but proper first version information Dver1 has not been obtained, the CPU 4 transmits an update cancellation request to the CGWECU 103a in Step S155.

When determination is made that no error is present or when an error has been corrected and proper first version information Dver1 has been obtained, the CPU 4 executes a new/old version comparison process (version verification process) in Step S156.

In the new/old version comparison process, the version information (referred to as “second version information Dver2”) of the pre-update software program SWP (referred to as “second software program SWP2”) currently installed in the ECU 1 is compared with the first version information Dver1 obtained in Step S152 or S153.

In Step S157, the CPU 4 executes a branching process based on a result of the new/old version comparison process. For example, the CPU 4 determines “No” in Step S157 when determination is made that the second version information Dver2 is newer. In this case, the CPU 4 cancels the update process by transmitting a cancellation request to the CGWECU 103a in Step S155.

The CPU 4 determines “Yes” in Step S157 when determination is made that the first version information Dver1 is newer. In this case, the CPU 4 proceeds to Step S158 of FIG. 9 to transmit, to the CGWECU 103a, a transmission request for the remaining data subsequent to the partial data Dp.

The CPU 4 receives the remaining data from the CGWECU 103a in Step S159, and executes a process of decrypting the remaining data in Step S160.

In Step S161, the CPU 4 executes a process of overwriting an area storing the second software program SWP2 with the first software program SWP1 in the decrypted remaining data. Thus, the second software program SWP2 installed in the ECU 1 is deleted and the first software program SWP1 is installed instead.

In Step S162, the CPU 4 generates an authenticator AC. In the authenticator generation process, an electronic signature or a MAC is newly generated as the authenticator AC from the first software program SWP1 in the decrypted remaining data.

In Step S163, the CPU 4 executes a process of comparing the authenticators AC. In the comparison process, the validity of the first software program SWP1 written into the ECU 1 is verified by comparing the authenticator AC newly generated in Step S162 and the authenticator AC extracted from the remaining data obtained by the decryption process of Step S160 (authenticator AC generated by the server 300).

In Step S164, the CPU 4 executes a branching process based on a result of the comparison process (verification process) of Step $163.

When the validity of the first software program SWP1 is verified, the CPU 4 determines “Yes” and completes the update process illustrated in FIGS. 8 and 9.

When the validity of the first software program SWP1 is not obtained, the CPU 4 determines “No” and executes an addressing process in Step S165.

In the addressing process, for example, the coupling terminal 200 is requested via the CGWECU 103a to transmit the pre-update second software program SWP2 in order to write the second software program SWP2 into the ECU 1 again.

Alternatively, a notification process may be executed to notify a user that the update of the ECU 1 has failed and an unauthorized program may be written, and to suggest visit to a dealer etc. to correct the program.

The update target ECU 1 may be configured such that the ROM 5 does not have sufficient capacity to store multiple software programs SWP and the RAM 6 has several kilobytes to several tens of kilobytes.

For example, the ROM 5 stores the old-version second software program SWP2. In one embodiment, the ROM 5 may serve as a second storage area.

In Step S151 of FIG. 8, the CPU 4 of the ECU 1 receives the partial data Dp and stores the partial data Dp in the RAM 6. In one embodiment, the RAM 6 may serve as a first storage area.

The CPU 4 of the ECU 1 compares, on the RAM 6 (first storage area), the first version information Dver1 obtained by decrypting the partial data Dp and the second version information Dver2 on the old version.

When determination is made that the first version information Dver1 has no error and is newer than the second version information Dver2, the CPU 4 of the ECU 1 transmits a transmission request for the remaining data in the encrypted update data Duen to the CGWECU 103a in Step S158.

The CPU 4 of the ECU 1 executes Steps S159, S160, and S161 to delete the second software program SWP2 stored in the ROM 5 (second storage area) and perform a process of decrypting and storing the received remaining data.

Even if the ECU 1 does not have a sufficient storage area, an appropriate first software program SWP1 can be written while avoiding downgrading or degrading of the software program SWP.

Although the RAM 6 may serve as the first storage area and the ROM 5 may serve as the second storage area in this example, the ROM 5 may serve as both the first storage area that is a version verification work area and the second storage area that stores the software program SWP.

That is, the first storage area that is the version verification work area and the second storage area that stores the software program SWP may be provided as different areas in the same memory or provided in different memories.

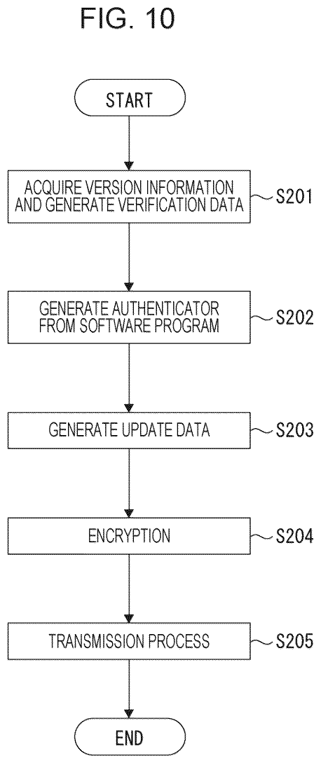

FIG. 10 illustrates an example of the process to be executed by the server 300.

In Step S201, the CPU 31 of the server 300 acquires first version information Dver1 of a first software program SWP1 to be transmitted and generates verification data Dval.

In Step S202, the CPU 31 of the server 300 generates an authenticator AC from the first software program SWP1.

In Step S203, the CPU 31 of the server 300 generates update data Du from the first version information Dver1, the verification data Dval, the first software program SWP1, and the authenticator AC.

In Step S204, the CPU 31 of the server 300 generates encrypted update data Duen by encrypting the update data Du.

In Step S205, the CPU 31 of the server 300 transmits the encrypted update data Duen to the coupling terminal 200.

After Step S205, the CPU 31 of the server 300 may receive a result of the update process from the coupling terminal 200.

Thus, the server 300 can record the update status of each vehicle 100.

When generating the authenticator AC from the encrypted update data Duen, the process of Step S202 may be executed after the encryption process of Step S204.

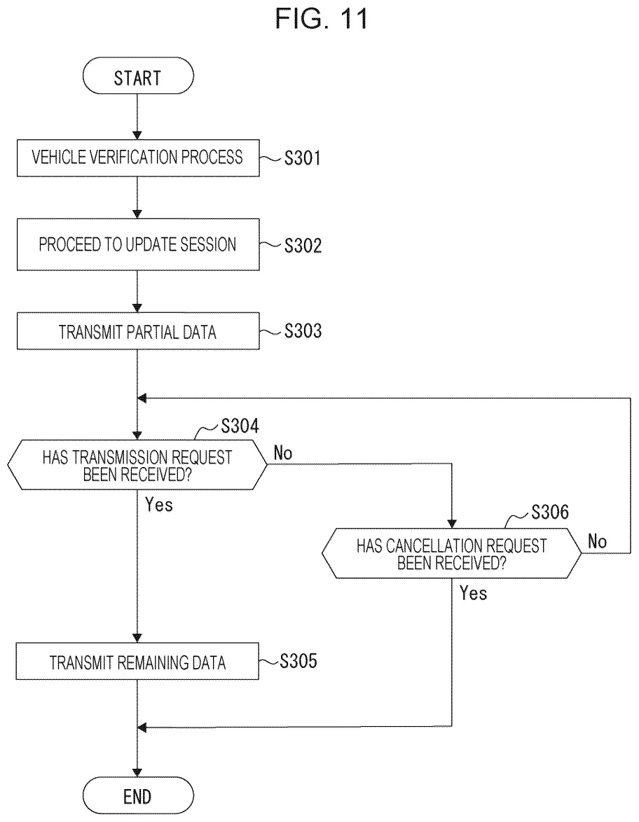

FIG. 11 illustrates an example of the process to be executed by the CPU 31 of the coupling terminal 200.

In Step S301, the CPU 31 of the coupling terminal 200 executes a vehicle verification process. This process is executed in conjunction with the process of Step S101 of FIG. 7 to verify whether the vehicle 100 includes the update target ECU 1.

In Step S302, the CPU 31 of the coupling terminal 200 proceeds to an update session. This process is executed in conjunction with the process of Step S102 of FIG. 7. In this process, for example, the RT installed in the coupling terminal 200 proceeds to an update mode.

In Step S303, the CPU 31 of the coupling terminal 200 transmits partial data Dp in the encrypted update data Duen to the CGWECU 103a of the vehicle 100.

In Step S304, the CPU 31 of the coupling terminal 200 determines whether a transmission request has been received. This transmission request is transmitted from the ECU 1 via the CGWECU 103a when the CGWECU 103a determines that the update can be executed through the determination about the version information Dver based on the received partial data Dp. For example, this transmission request is transmitted from the CGWECU 103a in Step S108 of FIG. 7.

When determination is made that the transmission request has been received, the CPU 31 of the coupling terminal 200 proceeds to Step S305 to transmit, to the CGWECU 103a, the remaining data that has not been transmitted in the encrypted update data Duen, and terminates the series of processes illustrated in FIG. 10.

When determination is made that the transmission request has not been received, the CPU 31 of the coupling terminal 200 determines in Step S306 whether a cancellation request has been received. This cancellation request is transmitted when the version is not verified successfully. For example, this cancellation request is transmitted from the CGWECU 103a in Step S107 of FIG. 7.

When determination is made that the cancellation request has been received, the CPU 31 of the coupling terminal 200 terminates the series of processes illustrated in FIG. 10. Thus, the partial data Dp alone in the encrypted update data Duen is transmitted to the CGWECU 103a.

When determination is made that the cancellation request has not been received, the CPU 31 of the coupling terminal 200 returns to the process of Step S304.

That is, the CPU 31 of the coupling terminal 200 repeats the processes of Steps S304 and S306 to wait for reception of any request from the CGWECU 103a.

When a predetermined period has elapsed during the repetition of the processes of Steps S304 and S306, the CPU 31 of the coupling terminal 200 may terminate the series of processes illustrated in FIG. 10 without receiving any request from the CGWECU 103a.

The CPU 31 of the coupling terminal 200 may transmit an update result to the server 300 after Step S305 or S306.

In the example described above, the update target ECU 1 executes the process illustrated in FIGS. 8 and 9, but the CGWECU 103a may execute part of the process illustrated in FIGS. 8 and 9.

For example, the CPU 4 of the CGWECU 103a may execute the process of decrypting the partial data Dp in Step S152, the error detection process of Step S153, the determination process of Step S154, the new/old version comparison process of Step S155, the determination process of Step S157, and the process of decrypting the remaining data in Step S160.

The CPU 4 of the CGWECU 103a may execute the processes of Steps S162 to S165 in place of the ECU 1.

In the example described above, the CGWECU 103a and the external coupling terminal 200 are provided separately, but the CGWECU 103a may have the functions of the coupling terminal 200. That is, the RT may be installed in the CGWECU 103a, and the CGWECU 103a may acquire the update data Du (encrypted update data Duen) from the server 300 via the DCM 104 and the communication network NW.

The ECU 1 (or the CGWECU 103a) that may serve as the information processing apparatus includes one or more processors (CPU 4) and a storage medium (ROM 5 or RAM 6) configured to store a program to be executed by the one or more processors. The program includes one or more instructions. The one or more instructions cause the one or more processors to execute the following processes.

That is, the one or more instructions cause the CPU 4 to execute a first reception process for receiving partial data Dp in update data Du including a first software program SWP1 and first version information Dver1 indicating a version of the first software program SWP1 and stored in an area closer to a head than is the first software program SWP1 (Step S151). The partial data Dp includes the first version information Dver1 and does not include the first software program SWP1. The one or more instructions cause the CPU 4 to execute a process for storing the partial data Dp in a first storage area (ROM 5 or RAM 6) (Step S151). The one or more instructions cause the CPU 4 to execute a process for comparing the first version information Dver1 in the partial data Dp and second version information Dver2 as to which is newer (Step S156). The second version information Dver2 indicates a version of a pre-update second software program SWP2 stored in a second storage area (ROM 5) expected to store the first software program SWP1. The one or more instructions cause the CPU 4 to execute a process for storing, in the second storage area, the first software program SWP1 (Step S161) received by a second reception process (Step S159) subsequent to the first reception process when determination is made that the first version information Dver1 is newer than the second version information Dver2 (Step S157: Yes).

With the configuration described above, an update process for updating the second software program SWP2 to the first software program SWP1 is executed based on a result of the comparison of the pieces of version information Dver as to which is newer.

For example, the update process can be canceled when the version of the first software program SWP1 is older than the version of the second software program SWP2. Thus, reoccurrence of a bug in the old software program SWP can be reduced.

Even if the coupling terminal 200 including the RT has undergone tampering and the program of the ECU 1 is rewritable in an unauthorized way, downgrading and rewriting to an unauthorized program can be suppressed by executing the process for comparing the pieces of version information Dver in the vehicle 100.

That is, abnormal operation and malfunction (bricking) of the ECU 1 (ECU 103, CGWECU 103a) can be reduced, and time and cost for rewriting to a proper program can also be reduced.

In particular, when the old and new software programs SWP cannot be stored together because of small capacity of the ROM 5, the old software program SWP is deleted during rewriting. Therefore, it is difficult to restore the program to a proper program.

Even in this case, the configuration described above is suitable because the rewriting of the software program SWP can be canceled depending on the result of the new/old version comparison process.

In the ECU 1 (or the CGWECU 103a) that may serve as the information processing apparatus, the update data Du may be encrypted data (encrypted update data Duen). The partial data Dp may include verification data Dval to be used for verifying whether the first version information Dver1 is correct. The one or more instructions may cause the one or more processors (CPU 4) to decrypt the partial data Dp (Step S152) in response to the first reception process (Step S151). The one or more instructions may cause the one or more processors (CPU 4) to execute a process for determining whether the first version information Dver1 is correct by using the decrypted verification data Dval (Step S153). The one or more instructions may cause the one or more processors (CPU 4) to decrypt the first software program SWP1 (Step S160) in response to the second reception process (Step S159) when the first version information Dver1 has no error (Step S154: No) and determination is made that the first version information Dver1 is newer than the second version information Dver2 (Step S157: Yes) in the process for comparing the first version information Dver1 and the second version information Dver2 as to which is newer (Step S156).

With the configuration described above, determination can be made as to whether the version information Dver has an error (tampering).

Thus, an update process using an old-version software program SWP can be suppressed. That is, abnormal operation and malfunction of the ECU 1 (ECU 103, CGWECU 103a) can be reduced appropriately.

In the ECU 1 (or the CGWECU 103a) that may serve as the information processing apparatus, the one or more instructions may cause the one or more processors (CPU 4) to cancel the process for storing the first software program SWP1 in the second storage area (ROM 5) (Step S155) when determination is made that the first version information Dver1 is older than the second version information Dver2 (Step S157: No) in the process for comparing the first version information Dver1 and the second version information Dver2 as to which is newer (Step S156).

With the configuration described above, the software program SWP stored in the storage area is a newer program.

Thus, downgrading or degrading of the program can be suppressed.

In the ECU 1 (or the CGWECU 103a) that may serve as the information processing apparatus, the one or more instructions may cause the one or more processors (CPU 4) to transmit a transmission request for the remaining data including the first software program SWP1 in the update data Du (Step S158) when determination is made that the first version information Dver1 is newer than the second version information Dver2 (Step S157: Yes) in the process for comparing the first version information Dver1 and the second version information Dver2 as to which is newer (Step S156).

With the configuration described above, the storage area provided in the vehicle 100 may have capacity to additionally store the partial data Dp while one software program SWP is installed.

That is, it is possible to suppress writing of an unauthorized software program SWP into the ECU 1 including the storage (ROM 5, RAM 6) having the storage area with small capacity, thereby executing an appropriate update process.

In the ECU 1 (or the CGWECU 103a) that may serve as the information processing apparatus, the one or more instructions may cause the one or more processors (CPU 4) to transmit a cancellation request for transmission of the remaining data including the first software program SWP1 in the update data Du (Step S155) when determination is made that the first version information Dver1 is older than the second version information Dver2 (Step S157: No) in the process for comparing the first version information Dver1 and the second version information Dver2 as to which is newer (Step S156).

With the configuration described above, the process for transmitting and receiving the old-version software program SWP is reduced. That is, the amount of communication can be saved.

The embodiment and the modifications described above can be combined as appropriate.

According to the embodiment of the disclosure, the software program can be updated appropriately.

The ECU 1 illustrated in FIG. 1 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the ECU 1. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 1.

1. An information processing apparatus comprising:
one or more processors; and
a storage medium storing a program configured to be executed by the one or more processors,
wherein the program comprises one or more instructions, and
wherein the one or more instructions are configured to cause the one or more processors to execute:
a first reception process for receiving partial data in update data comprising a first software program and first version information indicating a version of the first software program and stored in an area closer to a head than is the first software program, the partial data including the first version information and not including the first software program;
a process for storing the partial data in a first storage area;
a process for comparing the first version information in the partial data and second version information as to which is newer, the second version information indicating a version of a pre-update second software program stored in a second storage area expected to store the first software program; and
a process for storing, in the second storage area, the first software program received by a second reception process subsequent to the first reception process when the first version information is determined to be newer than the second version information.

2. The information processing apparatus according to claim 1,
wherein the update data is encrypted data,
wherein the partial data comprises verification data configured to be used for verifying whether the first version information is correct, and
wherein the one or more instructions are configured to cause the one or more processors to:
decrypt the partial data in response to the first reception process;
execute a process for determining whether the first version information is correct by using the decrypted verification data; and
decrypt the first software program in response to the second reception process when the first version information has no error and the first version information is determined to be newer than the second version information in the process for comparing the first version information and the second version information as to which is newer.

3. The information processing apparatus according to claim 1, wherein the one or more instructions are configured to cause the one or more processors to cancel the process for storing the first software program in the second storage area when the first version information is determined to be older than the second version information in the process for comparing the first version information and the second version information as to which is newer.

4. The information processing apparatus according to claim 1, wherein the one or more instructions cause the one or more processors to transmit a transmission request for remaining data including the first software program in the update data when determination is made that the first version information is newer than the second version information in the process for comparing the first version information and the second version information as to which is newer.

5. The information processing apparatus according to claim 1, wherein the one or more instructions cause the one or more processors to transmit a cancellation request for transmission of remaining data including the first software program in the update data when determination is made that the first version information is older than the second version information in the process for comparing the first version information and the second version information as to which is newer.
